(19) United States
(12) Patent Application Publication
(10) Pub. No.: US 2025/0322508 A1
(43) Pub. Date: Oct. 16, 2025

(54) VISUAL INSPECTION OF OILFIELD EQUIPMENT USING MACHINE LEARNING

(71) Applicant: Cameron International Corporation, Houston, TX (US)

(72) Inventors: Sanjyot Samarth Zade, Pune (IN); Bradley Martin, Kuala Lumpur (MY); Ranveer Singh, Pune (IN); Sreekanth Asodi, Pune (IN); Michael Briggs, Houston, TX (US); Jaijith Sreekantan, Houston, TX (US); Kirk Paul Guidry, Houston, TX (US)

(21) Appl. No.: 19/090,641

(22) Filed: Mar. 26, 2025

(30) Foreign Application Priority Data
Apr. 12, 2024 (IN) 202411029866

(51) Int. Cl. G06T 7/00; G06V 10/25

(52) U.S. Cl. CPC G06T 7/0004; G06V 10/25; G06T 2200/24; G06T 2207/20081; G06T 2207/30164

(57) ABSTRACT

A non-transitory computer readable medium stores instructions that, when executed by a processor, cause the processor to receive, via a user interface of a mobile device, instructions to begin an inspection of a surface of a part, capture, via a camera of the mobile device, a video of the surface of the part as the mobile device is moved about the part, receive, via the user interface of the mobile device, information associated with the part, the inspection, or both, generate, via the processor of the mobile device, an inspection data set comprising the video and the information, and display, via the user interface of the mobile device, an indication of whether the surface of the part passed the inspection or failed the inspection based on a machine learning-based analysis of the inspection data set.

### BACKGROUND

The present disclosure relates generally to oilfield equipment inspection and, more specifically, to using machine learning and a mobile device to perform surface visual inspections.

Industrial operations, such as oil and gas exploration, evaluation, development and production of oil and gas reservoirs (e.g., surface, subsea, subsurface, etc.), as well as manufacturing, mining, construction, and so forth may utilize equipment in environments that may have high pressures, high temperatures, low temperatures, corrosive chemicals, and so forth that may accelerate equipment wear or otherwise stress equipment. Accordingly, enterprises engaged in such activities frequently perform inspections on equipment. Using a team of human inspectors may result in inconsistent inspection results due to human factors and variability between inspectors such as, for example, the inspector's experience, the inspector's application of inspection criteria, inspection location, equipment use or application, and so forth. Accordingly, techniques for more uniform equipment inspections across an enterprise are desired.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosed techniques are directed to a machine-learning based part inspection system that provides more uniform part inspection results across an enterprise, regardless of who performs the inspection. Specifically, a user uses a mobile or edge device to capture a video inspection of a part. The video may then be processed using one or more machine learning models. Processing may be done locally on the mobile or edge device, on a local server, on a remote server, on a cloud-based server, or some combination thereof. The analysis may include processing the video frame-by-frame. For each frame, processing may include identifying a region of interest, identifying instances of damage, determining if there is intersection between the region of interest and the instances of damage, determining if certain damage types are present in the frame or in a specific location in the frame, and then determining if the number of instances of damage that intersect the regions of interest exceed a threshold value. If so, the surface fails inspection. If not, the surface passes inspection.

The machine learning models may include, for example, an encoder-decoder-based deep neural network and/or image classification models. The machine learning models may be trained by receiving annotated images, classified images, and/or classified regions of images, and so forth received from subject matter experts (SMEs). The annotated images include annotations identifying particular features in images, such as surfaces, regions of interest, damage, and so forth. Classified images may include damage type, part features, or image feature such as image height or image orientation. Once trained, the machine learning models may be used to process inspections received from inspectors throughout the enterprise or from users outside of the enterprise, such as third parties, customers, users of equipment, and so forth. Periodically, the machine learning models may be further trained based on feedback from inspectors and/or SMEs.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRA WINGS

Various aspects of this disclosure may be better understood upon reading the following detailed description and upon reference to the drawings in which:

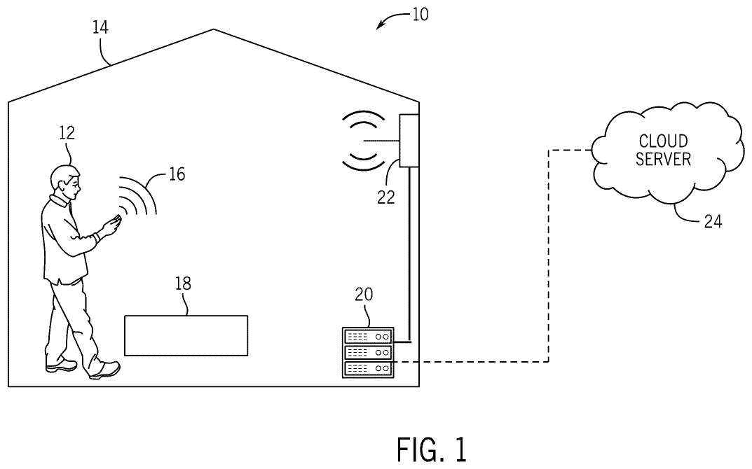

FIG. 1 is a schematic of an embodiment of a part inspection system, in accordance with aspects of the present disclosure;

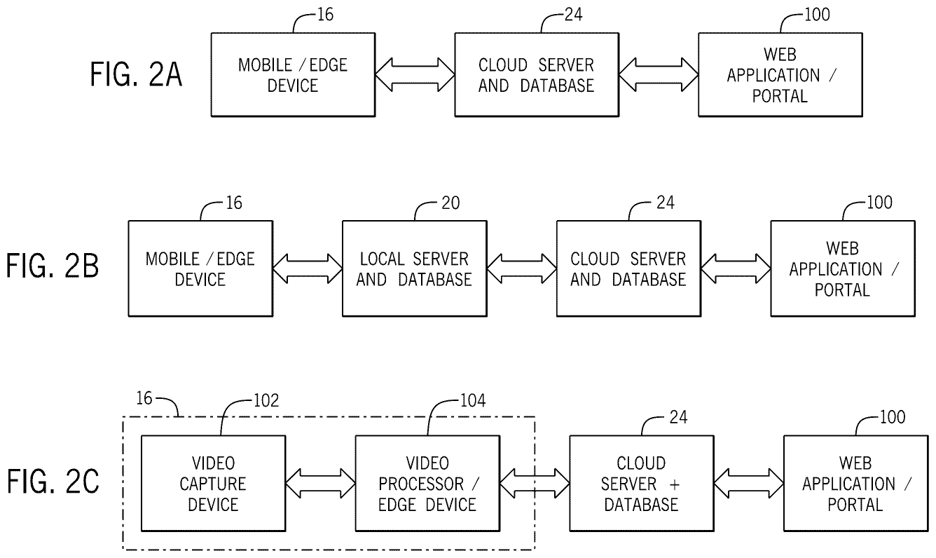

FIG. 2A illustrates an embodiment in which an imaging device is a mobile device, such as a cellular phone, tablet, or other device (e.g., edge device) equipped with a camera and cellular or wireless internet communication capabilities, in accordance with aspects of the present disclosure;

FIG. 2B illustrates an embodiment in which the imaging device captures images and/or video of a part and transmits data to a local computing device, such as a local server and/or database for processing, in accordance with aspects of the present disclosure;

FIG. 2C illustrates an embodiment in which the imaging device captures images and/or video of the part via a video capture device, such as an onboard camera, and performs some processing of the captured images and/or video via a video processor (e.g., a hardware processor configured to execute image/video processing software) and transmits data to the cloud/remote server, in accordance with aspects of the present disclosure;

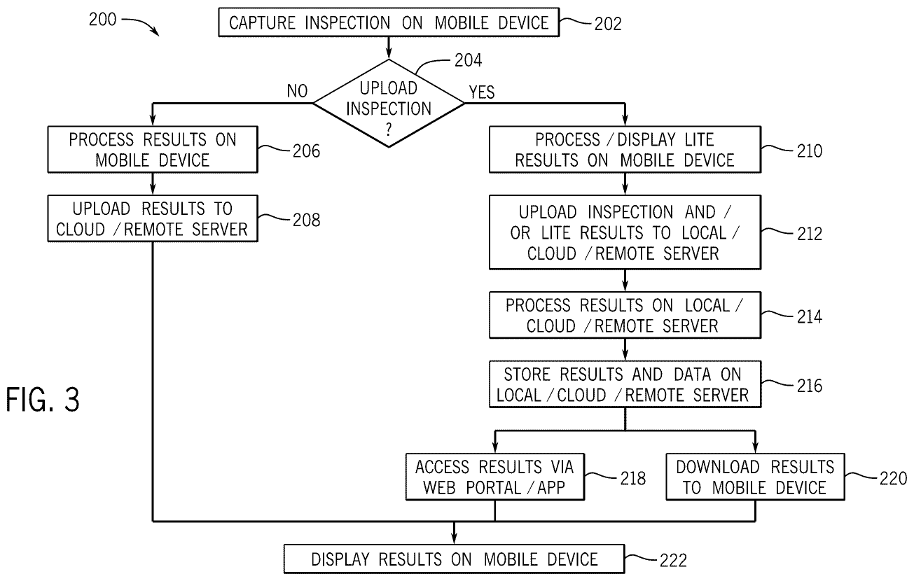

FIG. 3 is a flow chart of a process for performing part inspections, in accordance with aspects of the present disclosure;

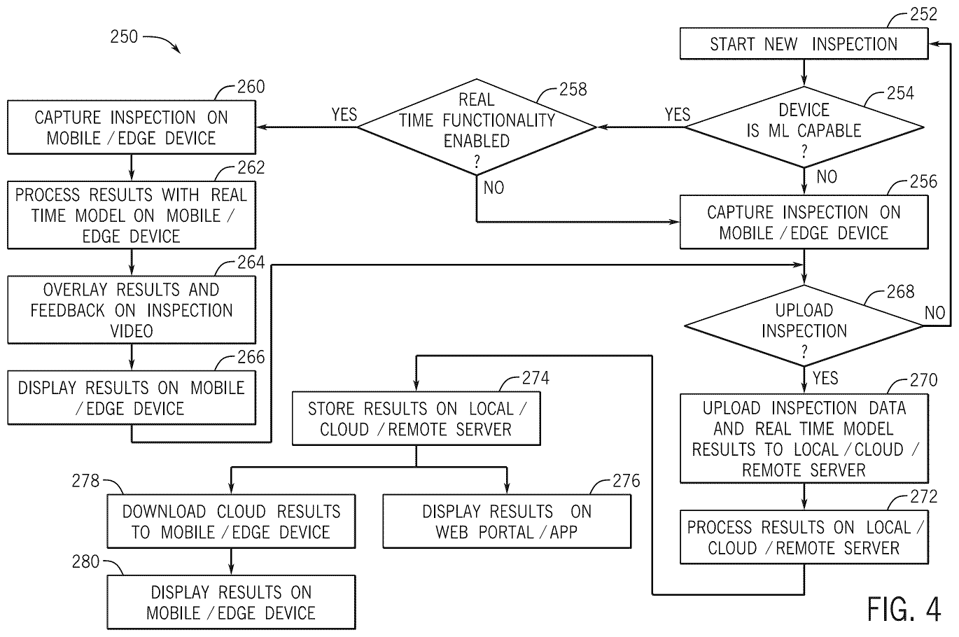

FIG. 4 is a flow chart of a process for performing part inspections that considers whether a mobile or edge device is capable of running models locally, in accordance with aspects of the present disclosure;

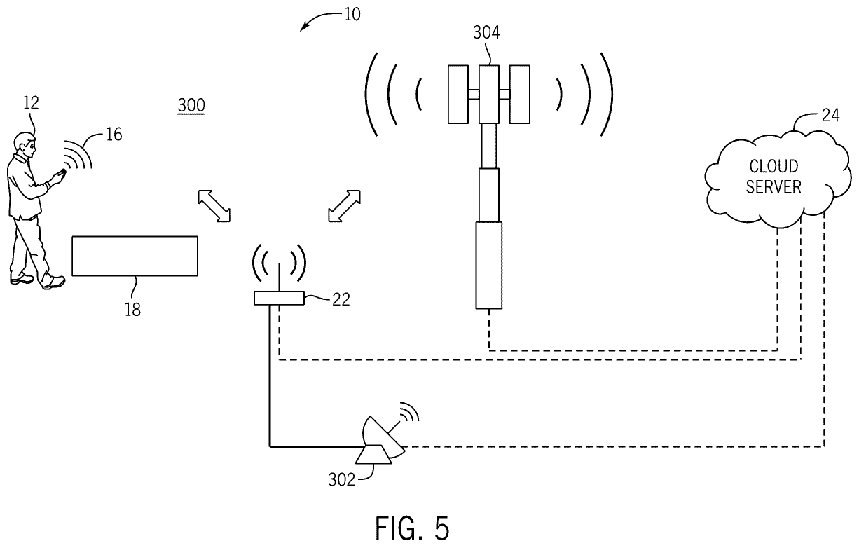

FIG. 5 is a schematic of an embodiment of the part inspection system of FIG. 1 in which the inspector performs an inspection from a remote field location, in accordance with aspects of the present disclosure;

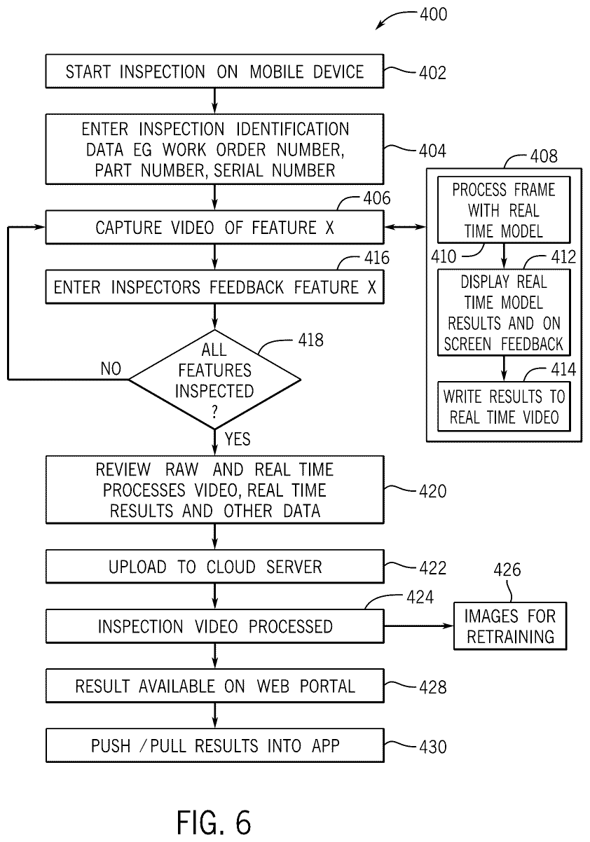

FIG. 6 is a flow chart of an example inspection process from the perspective of the mobile device used to perform inspections, in accordance with aspects of the present disclosure;

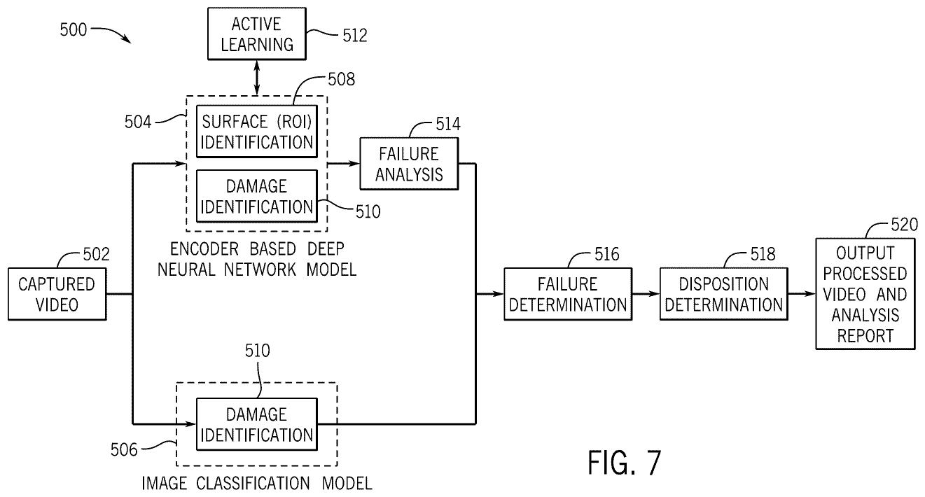

FIG. 7 is a schematic illustrating an example inspection processing workflow for processing on a local server, cloud server, and/or remote server, or when post-processing results on a mobile or edge device, in accordance with aspects of the present disclosure;

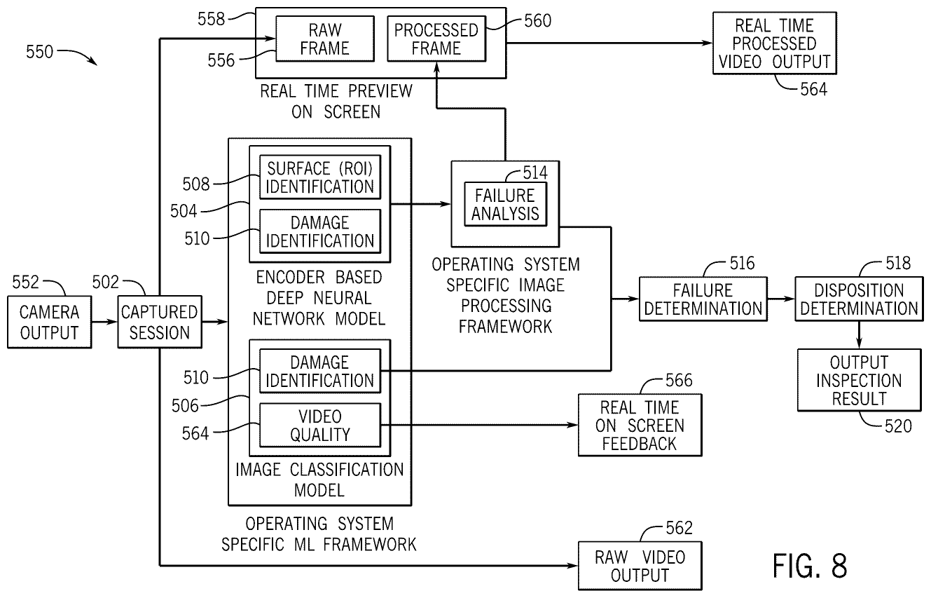

FIG. 8 is a schematic illustrating an example inspection processing workflow for processing an inspection in real time or near real time, in accordance with aspects of the present disclosure;

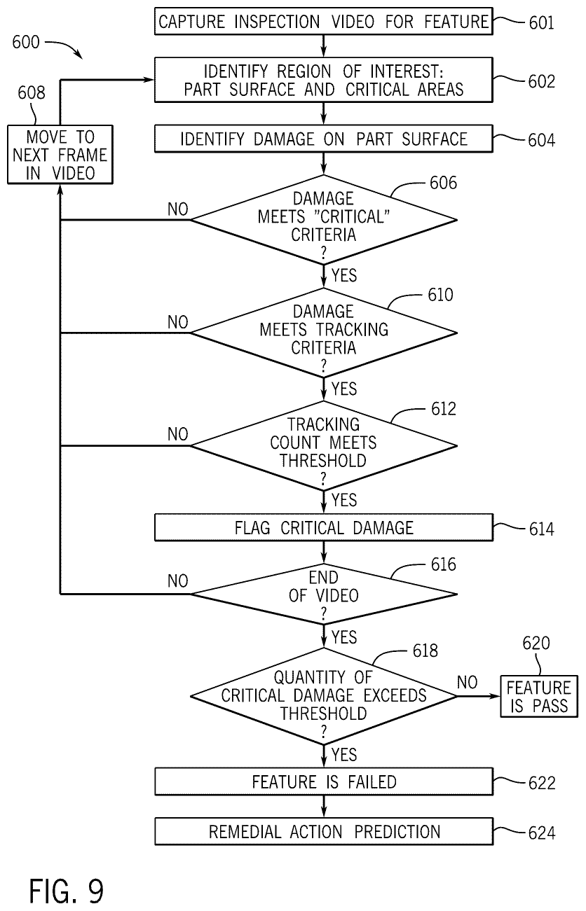

FIG. 9 is a flow chart of a process for processing the inspection of a feature of a part with the encoder-decoder based deep neural network model predictions, in accordance with aspects of the present disclosure;

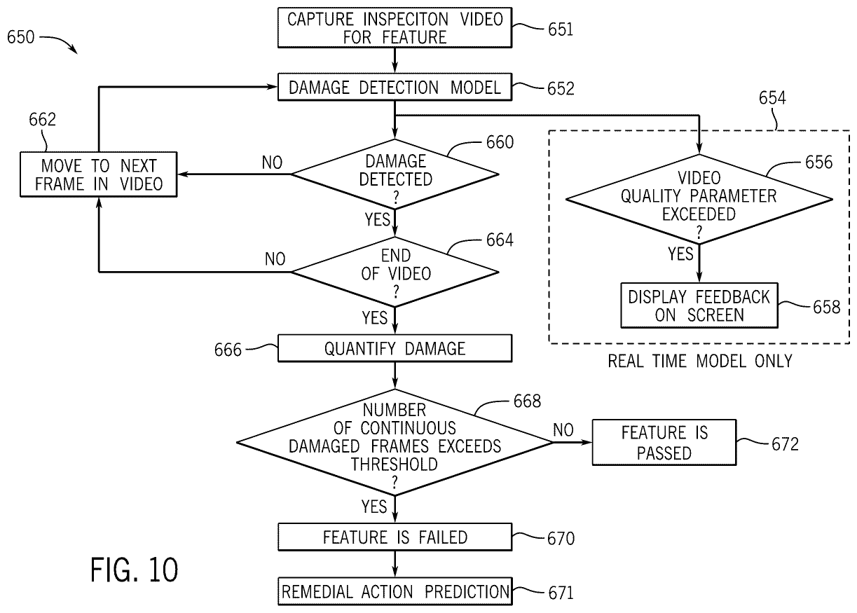

FIG. 10 is a flow chart of a process for processing the inspection failure result with the classification model predictions, in accordance with aspects of the present disclosure;

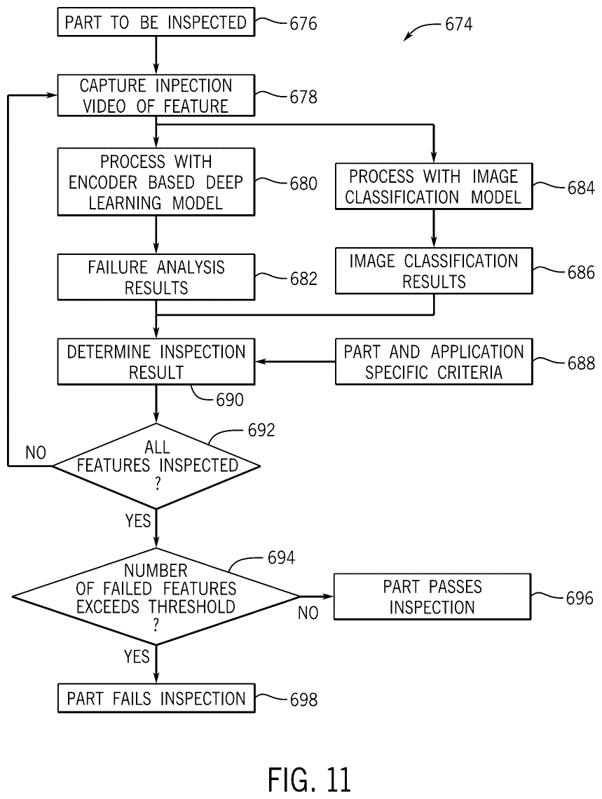

FIG. 11 is a flow chart of a process for performing inspections of parts, in accordance with aspects of the present disclosure;

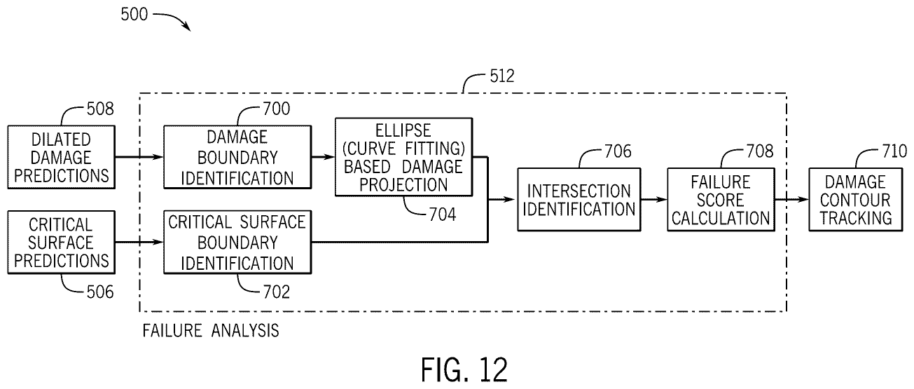

FIG. 12 is a schematic illustrating specifics of the failure analysis block in the inspection processing workflow of FIG. 6, in accordance with aspects of the present disclosure;

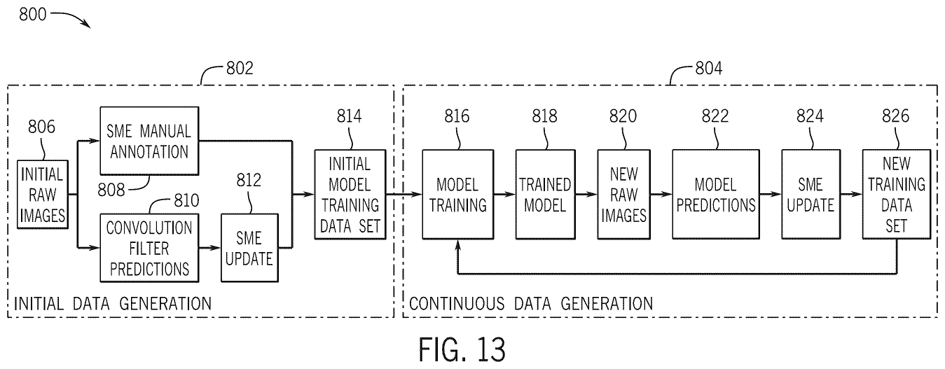

FIG. 13 is a schematic illustrating a process for training deep learning models used to process inspections, in accordance with aspects of the present disclosure;

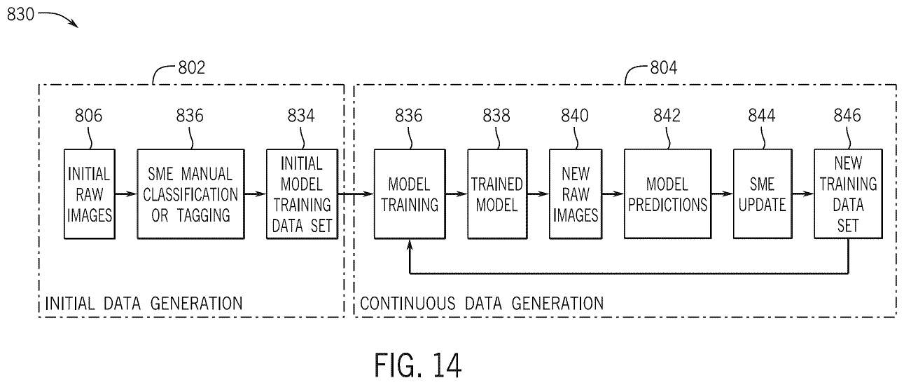

FIG. 14 is a schematic illustrating a process for training image classification models used to process inspections, in accordance with aspects of the present disclosure;

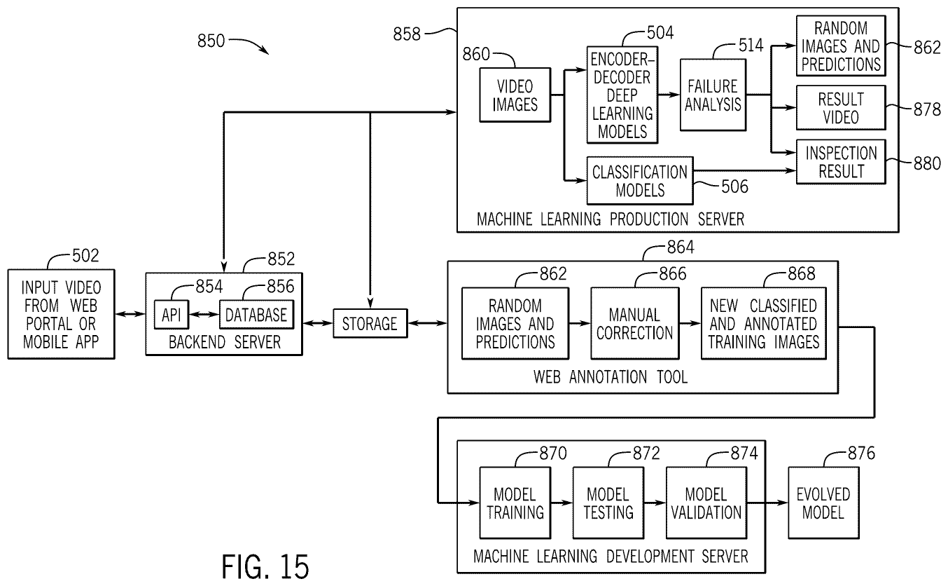

FIG. 15 is a schematic of a web-based, end to end video testing and data generation platform used for processing part inspections, in accordance with aspects of the present disclosure;

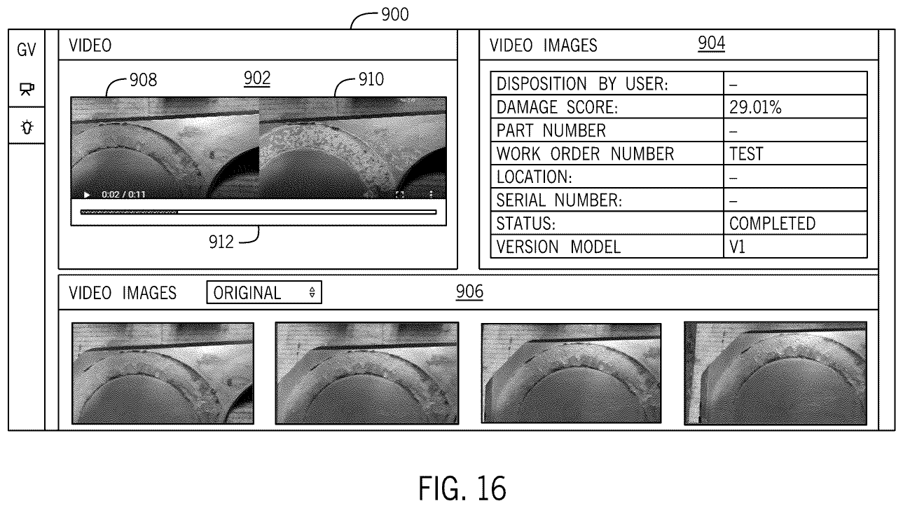

FIG. 16 is a screenshot of an image annotation tool in video mode, in accordance with aspects of the present disclosure;

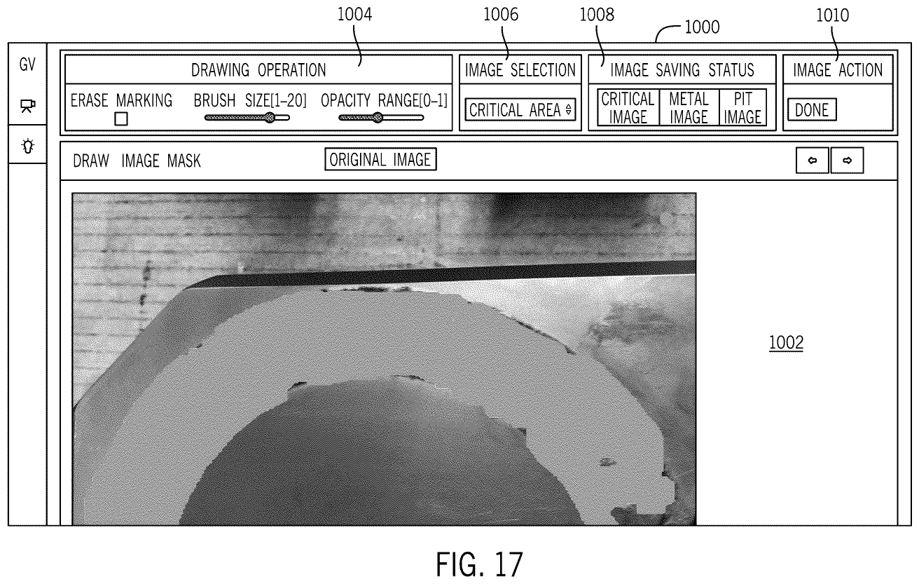

FIG. 17 is a screenshot of the image annotation tool of FIG. 16 in image annotation mode, in accordance with aspects of the present disclosure; and

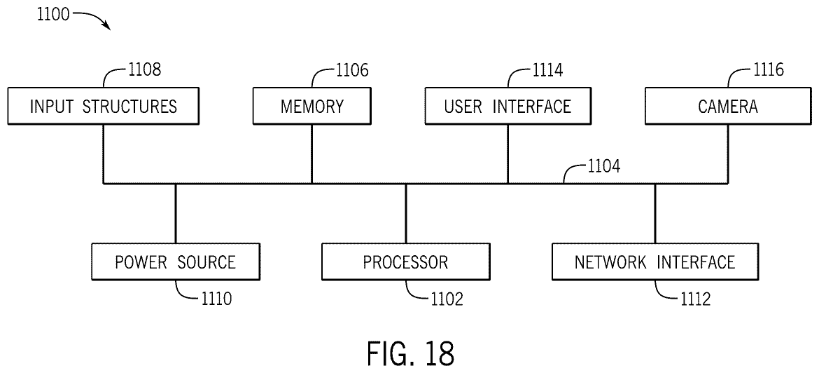

FIG. 18 is a block diagram of example components of a computing device, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Typically, enterprises rely on human inspection of parts to determine whether parts can continue being used, should be serviced, or should be replaced. For example, oil and gas enterprises may rely on human inspectors to perform visual inspection of a part (e.g., a part from an oil field equipment asset) to assess one or more aspects of the part (e.g., the surface condition of the oilfield equipment and related parts). During visual inspection of a part, an inspector may examine an internal or external surface of the part for evidence of damage, defects, or combinations of multiple smaller damage areas in particular locations on the surface of the part that are considered critical, for example, damage in or near the sealing area that could create a leak path across a sealing mechanism from the high pressure to low pressure side, cause secondary damage (transfer of damage) to other parts of the equipment (e.g., damage on a piston causing damage to the cylinder it is installed into, and/or damage in a seal groove resulting in damage to an o-ring), prevent proper function or prevent proper assembly/disassembly, and/or cause other issues.

In the oilfield equipment surface condition inspection example, a qualified inspector observes the surface condition of a piece of oilfield equipment, noting any differences or abnormalities compared to a new or as new piece of oilfield equipment. The inspector may use standard criteria to assess the surface condition (or other aspects) of the part. In some embodiments, the criteria may be a visual guideline, such as photographs or drawings illustrating characteristics that may be acceptable and/or not acceptable. In some embodiments, the criteria may set forth dimensions of acceptable and/or unacceptable feature characteristics, such as feature type, length, width, depth, position relative to some reference point, etc.). In some cases, the acceptance criteria may not be well defined, or may be open to interpretation based on the inspector's experience. Accordingly, different interpretations of the acceptance criteria, as well as varied experience levels, exposure to different parts, different types of damage, personal bias and other external factor such as customer or management influence may result in inconsistent assessment of the condition of the equipment or part under inspection such that same part may pass inspection by one inspector but fail inspection by another inspector.

In the event that a part that would otherwise fail inspection passes inspection, the part is re-used and/or returned to service and may have issues that result in downtime, lost time, lost resources, etc. Correspondingly, in the event that a part that would otherwise pass inspection fails inspection, the part is unnecessarily repaired, serviced, and/or replaced, resulting in resources lost repairing, servicing, or replacing the part that would have passed inspection. In addition, unnecessarily repairing, servicing, or replacing the part may result in delays returning the asset to service while new parts are procured, potentially requiring additional equipment or lost revenue. To mitigate this, some enterprises maintain large inventories of spare parts, resulting in high inventory and storage costs.

Accordingly, the present disclosure is directed to a machine-learning based part inspection system that provides more uniform part inspection results across an enterprise, regardless of who performs the inspection. With the foregoing in mind, FIG. 1 is a schematic of an embodiment of a part inspection system 10. As shown, an inspector 12 disposed at a facility 14 utilizes an imaging device 16 to capture video and/or images of a part 18. The inspector 12 may be an operator of the part 18, an inspector specifically assigned to inspect an enterprise's assets, or any other person that performs inspections for the enterprise. Similarly, the facility 14 may be an inspection facility at which assets are inspected, a storage facility, a facility at which the assets are used, a maintenance facility, a service/repair facility, a manufacturing facility, and so forth. Indeed, in some embodiments (e.g., shown and described with regard to FIG. 5), the facility 14 may not be an enclosed facility at all, but a remote (e.g., outdoor) location in the field (e.g., a location at which assets 18 are unpacked, assembled, operated, packed, transported, serviced, maintained, etc., such as a wellsite, drilling rig, and so forth). The imaging device 16 may be a cellular phone, a tablet, some other mobile device or edge device, a still image camera, a video camera, or any other device capable of capturing still images or video. Accordingly, in some embodiments, the images generated by the imaging device 16 may be still photographs or videos. In some embodiments, the imaging device 16 may include infrared sensors, radar, x-ray, gamma ray, magnetic resonance imaging (MRI) sensors, or other types of sensors that may generate still or moving images, even if those images may not be photographs or video. Though the part 18 may be described herein as a gate of a gate valve used in oil and gas extraction using hydraulic fracturing, it should be understood that embodiments are envisaged in which the present techniques may be applied to other oilfield equipment, and even equivalent equipment or applications outside of the oil and gas industry.

As shown, the inspector 12 uses the imaging device 16 to capture images and/or video of the part 18. In some embodiments, the imaging device 16 may include a processor or other computing resources that may be used to analyze the captured images and/or video or perform some pre-processing of the captured images and/or video. In some embodiments, the imaging device 16 may be communicatively coupled (e.g., by a wired network, a wireless network, a satellite network, a wired connection, or some wireless connection, such as Bluetooth, near field communication (NFC), etc.) to a computing device 20, such as a server. For example, in the embodiment shown in FIG. 1, the imaging device 16 may be in communication with the computing device 20 via a piece of networking equipment 22, such as a wireless router. The computing device 20 may perform some analysis of the captured images and/or video received from the imaging device 16. In some embodiments, the computing device 20 may transmit data (e.g., the captured images and/or video and/or data generated in analyzing the captured images and/or video) to a cloud server 24 or remote server for analysis. In further embodiments, the imaging device 16 may transmit data (e.g., the captured images and/or video and/or data generated in analyzing the captured images and/or video) directly to the cloud/remote server 24.

As will be described in more detail below, the processing of the captured images and/or video may be performed on the imaging device 16, on the local computing device 20, on the remote/cloud server 24, or some combination thereof to determine whether or not the part passes inspection. FIG. 2A illustrates an embodiment in which the imaging device 16 is a mobile device, such as a cellular phone, tablet, or other device (e.g., edge device) equipped with a camera and cellular or wireless internet communication capabilities. As shown, the mobile device 16 captures images and/or video of a part, in some instances generates results of the inspection, and transmits data (e.g., the captured images and/or video and/or data generated in analyzing the captured images and/or video) directly to the cloud/remote server 24. The cloud/remote server 24 analyzes the transmitted data, and generates results of the inspection, including whether or not the part has passed inspection, which may be available via a web application 100, portal, or native application, which may accessible via the mobile device 16 or other computing device 20.

FIG. 2B illustrates an embodiment in which the imaging device 16 captures images and/or video of a part and transmits data (e.g., the captured images and/or video and/or data generated in analyzing the captured images and/or video) to a local computing device 20, such as a local server and/or database. The local computing device 20 may or may not perform some processing of the received data (e.g., the captured images and/or video and/or data generated in analyzing the captured images and/or video) and then transmits data (e.g., the captured images and/or video and/or data generated in analyzing the captured images and/or video) to the cloud/remote server 24. The cloud/remote server 24 analyzes the received data, and generates results of the inspection, including whether or not the part has passed inspection, which may be available via the web application 100, portal, or native application, which may accessible via the mobile device 16 or other computing device 20.

FIG. 2C illustrates an embodiment in which the imaging device 16 captures images and/or video of a part via a video capture device 102, such as an onboard camera, and performs some processing of the captured images and/or video via a video processor 104 (e.g., a hardware processor configured to execute image/video processing software) and transmits data (e.g., the captured images and/or video and/or data generated in analyzing the captured images and/or video) to the cloud/remote server 24. The cloud/remote server 24 analyzes the received data, and generates results of the inspection, including whether or not the part has passed inspection, which may be available via the web application 100, portal, or native application, which may accessible via the mobile device 16 or other computing device 20.

FIG. 3 is a flow chart of a process 200 for performing part inspections. At block 202, an inspection is captured on a mobile device, or other imaging device, by capturing one or more videos and/or images of the part to be inspected. For example, if the inspection is focused on a particular surface or feature of the part, the inspector may capture a video (e.g., 15 second, 30 seconds, 1 minute, etc.) and/or a series of images of the surface or feature being inspected from a range of different perspectives. Typically, the part being inspected is stationary and videos captured with a mobile device (e.g., tablet, phone) or video capture device may be hand held by the user. However, in some embodiments, the imaging device may be mounted on a mechanical device to automate the movement of the camera such as a movable support frame, moveable camera controlled by servo motors or a robotic arm. In other embodiments, the imaging device may be fixed and the part moved relative to the camera such as on a moving conveyer belt or rotating table.

Inspection may be performed on equipment assemblies, subassemblies, or parts. Accordingly, parts may be inspected in an installed state, an assembled state, a disassembled state, and so forth. Though the term “part” is used herein, is should be understood that the disclosed techniques may be applied to assets or assemblies having multiple parts or subassemblies. In one example, the part being inspected may include a slab gate valve metal gate and seat that form a metal-to-metal seal. The inspection may be used to determine the condition of the face of the gate. For example, damage and/or defects in and around the sealing area may keep the gate valve from establishing and/or maintaining a seal. Accordingly, parts and equipment may be inspected during manufacturing, during/after shipment, storage, during maintenance, after use in the field (e.g., at the wellsite, on the rig, on the platform, etc.) and so forth. During manufacturing, parts may be inspected during the manufacturing process, for example before or after machining/finishing. In the field, equipment and parts may be inspected onsite or returned to a maintenance facility. Equipment may be inspected as part of an assembly of equipment, for example installed on a truck, skid, on a well or in a well. For example, a tubing hanger in a wellhead, gate valve in a Christmas tree (surface or subsea), ball valve in a subsurface completion, well casing installed in a well (permanent or temporary), blowout preventer (BOP) rams, flange on separator inlet/outlet, and so forth. In some embodiments, equipment may be removed from its normal installation, and/or partially or fully disassembled and inspected (e.g., as a whole, as subassemblies, and/or as constituent parts).

At decision 204, the process 200 determines whether the inspection is to be processed real time on the mobile device, for example if the mobile device has sufficient processing capabilities (e.g., CPU, GPU or other type of processors), or if the user requires the processing in real time, the inspection may be processed in real time on the mobile device. In such embodiments, a local and/or lite version of the models may be incorporated in the mobile device and may be used to determine a preliminary inspection pass or fail. Complete analysis may be performed later via a local/cloud/remote server. If a device is available with sufficient computing resources, a full version of the models may be run on the device and only the results uploaded to the cloud for archiving and/or model development. At block 206 the mobile device may perform some pre-processing or partial processing of the inspection before uploading to the local/cloud/remote server. For example, the mobile device may crop data, remove anomalous data, apply one or more filters, apply one or more pre-processing algorithms, add metadata, apply one or more lite models to generate lite results (e.g., a smaller package of data for upload to the local/cloud/remote server, a quick pass to determine whether pass or fail may be quickly determined, etc.), and so forth. As described in more detail below, the processing may include, for example, using a machine learning model to analyze each image taken, or each frame of the one or more videos taken, identifying characteristics (e.g., damage, such as scratches, pitting, etc.), tracking identified characteristics between images or frames to confirm their existence, determining whether the identified characteristics are severe enough to fail inspection. The pass/fail criteria for each part or feature of a part may be defined for that part based on its design, functionality, location/role in a process or system, the application of the part or feature, and use conditions of the part or feature.

For example, equipment used in the exploration, evaluation, development and production of oil and gas reservoirs (e.g., surface, subsea and subsurface environments) may be subject to unusual conditions such as high pressure (e.g., up to and exceeding 15,000psi), high temperatures (e.g., up to and exceeding 250 degrees Fahrenheit), exposure to solid particles originating from geological formations, drilling processes and hydraulic fracturing, corrosive chemicals, exposure to produced fluids and gases, and so forth, which may result in damage to the equipment that may affect the equipment's performance (e.g., ability to hold and maintain a seal). In the case of pressure retaining equipment, damage to seals, sealing surfaces and sealing mechanisms may result in small leaks through to rupture (venting to the environment). Damage may also occur as a result of equipment being mishandled, equipment being improperly assembled, impact with other oilfield equipment (e.g., a wireline perforating tool dropping onto a closed master valve in a Christmas tree), and so forth. Corrosion may occur when parts are left idle for some time exposed to the environment or corrosive chemicals. Galling may occur when surfaces of two similar metals are in contact.

In some embodiments, at block 208 inspection results may be uploaded to a local/cloud/remote server for storage and/or further analysis. For example, in embodiments in which internet and/or network connections are unreliable, intermittent, or only periodically available, the inspector may wish to immediately use the results process locally on the device and then upload inspection results to a local/cloud/remote server when a connection is available. However, in other embodiments, the inspection may be performed in a remote location without internet and/or network connections. In such embodiments, uploading results to a local/cloud/remote server may be omitted entirely or delayed until internet and/or network connections are available. In other embodiments, videos/images may be captured using a camera that may not have internet/networking capabilities. In such embodiments, the videos/images may be downloaded from the camera and uploaded to a local/cloud/remote server via a web application, native application, a portal, and so forth.

If, at decision 204, the inspection is to be uploaded to a local/cloud/remote server, the process 200 may proceed to block 210. In some embodiments, an inspector may prefer faster processing of inspection results for faster decisions compared to cloud based processing. In such embodiments, a local and/or lite version of the models may be stored on the mobile devoice and may be used to determine a preliminary inspection pass or fail. Complete analysis may be performed later via a local/cloud/remote server. If a device is available with sufficient computing resources, a full version of the models may be run on the device and only the results uploaded to the cloud for archiving and/or model development. At block 210, the mobile device may perform some pre-processing or partial processing of the inspection before uploading to the local/cloud/remote server. For example, the mobile device may crop data, remove anomalous data, apply one or more filters, apply one or more pre-processing algorithms, add metadata, apply one or more lite models to generate lite results (e.g., a smaller package of data for upload to the local/cloud/remote server, a quick pass to determine whether pass or fail may be quickly determined, etc.), and so forth.

It should be understood, however, that in some embodiments, block 210 may be omitted and the process 200 may proceed to block 212. At block 212, the process 200 uploads the inspection and/or lite results to the local/cloud/remote server for processing and/or storage. In field and/or wellsite use, the mobile device may transmit inspection data via a cellular network to the remote/cloud server. Alternatively, the mobile device may communicate inspection data via a wired or wireless connection to a local gateway to provide inspection data to a local server or the remote/cloud server via a cellular network, satellite, landline, wired network, wireless network, the internet, and so forth.

At block 214, the local/cloud/remote server processes the received inspection and/or lite results. The processing may include, for example, using a machine learning model to analyze images taken, or individual frames of the one or more videos taken, identifying characteristics (e.g., damage, such as scratches, pitting, etc.), tracking identified characteristics between images or frames to confirm their existence, determining whether the identified characteristics are significant enough to fail inspection. The pass/fail criteria for each part or feature of a part may be defined for that part based on its design, functionality, location/role in a process or system, the application of the part or feature, and use conditions of the part or feature. At block 216, the inspection results, lite results, and/or inspection may be stored on the local/cloud/remote server. In some embodiments, the inspection results, lite results, and/or inspection may be uploaded or otherwise transmitted to another local/cloud/remote server for storage and/or additional processing. For example, in some embodiments, the inspection results, lite results, and/or inspection may be added to a training data set or otherwise used to train, evaluate, or otherwise improve a machine learning algorithm for processing subsequent inspections.

Once the inspection has been processed by the local/cloud/remote server and results have been generated, results may be accessed via a web portal, web application, or native application (block 218), or downloaded to the mobile or edge device (block 220). Once results are accessed locally or via the web portal, web application, or native application, results may be displayed (block 222) via the mobile or edge device, or some other computing device, such as a desktop computer, a laptop/notebook computer, a workstation, a cellular phone, a tablet, and so forth.

FIG. 4 is a flow chart of a process 250 for performing part inspections that considers whether the mobile or edge device is capable of running models locally. At block 252, a new inspection is initiated. At block 254, the process 250 determines whether the mobile or edge device is capable of running ML models locally. If not, the process 250 proceeds to block 256 and captures an inspection on the mobile or edge device. As previously discussed, the inspection may include capturing one or more videos and/or images of the part to be inspected. For example, if the inspection is focused on a particular surface or feature of the part, the inspector may capture a video (e.g., 15 second, 30 seconds, 1 minute, etc.) and/or a series of images of the surface or feature being inspected from a variety of different perspectives. Typically, the part being inspected is stationary and videos captured with a mobile device (e.g., tablet, phone) or video capture device may be held by the user. However, in some embodiments, the imaging device may be mounted on a mechanical device to automate the movement of the camera such as a movable support frame, moveable camera controlled by servo motors or a robotic arm. In other embodiments, the imaging device may be fixed and the part moved relative to the camera such as on a moving conveyer belt or rotating table.

If, at decision 254, the mobile or edge device is capable of running ML models locally, the process 250 proceeds to decision 258 and determines whether the mobile or edge device has real time functionality enabled. If not, the process 250 proceeds to block 256 and captures the inspection on the mobile or edge device without real time functionality enabled. If so, the process 250 proceeds to block 260 and captures the inspection on the mobile or edge device with real time functionality enabled.

At block 262, the results are processed with a real time model on the mobile or edge device. For example, the mobile or edge device may crop data, remove anomalous data, apply one or more filters, apply one or more pre-processing algorithms, add metadata, apply one or more lite models to generate lite results (e.g., a smaller package of data for upload to the local/cloud/remote server, a quick pass to determine whether pass or fail may be quickly determined, etc.), and so forth. Further, processing may include, for example, using a real-time or near-real time machine learning model to analyze each image taken, or each frame of the one or more videos taken, identifying characteristics (e.g., damage, such as scratches, pitting, etc.), tracking identified characteristics between images or frames to confirm their existence, determining whether the identified characteristics are severe enough to fail inspection. The pass/fail criteria for each part or feature of a part may be defined for that part based on its design, functionality, location/role in a process or system, the application of the part or feature, and use conditions of the part or feature. At block 264, results and feedback may be overlaid on the inspection photos and/or video. At block 266, the results may be displayed on the mobile or edge device.

At decision 268, the process determines whether to upload the inspection. If the inspection is not the be uploaded, the process 250 ends. If the inspection is to be uploaded, the process 250 proceeds to block 270 and uploads the inspection data and real time model results to a local, cloud, and/or remote server for processing and/or storage. In field and/or wellsite use, the mobile or edge device may transmit inspection data via a cellular network to the remote/cloud server. Alternatively, the mobile device may communicate inspection data via a wired or wireless connection to a local gateway to provide inspection data to a local server or the remote/cloud server via a cellular network, satellite, landline, wired network, wireless network, the internet, and so forth.

At block 272, results may be processes by the local, cloud, and/or remote server. The processing may include, for example, using a machine learning model to analyze images taken, or individual frames of the one or more videos taken, identifying characteristics (e.g., damage, such as scratches, pitting, etc.), tracking identified characteristics between images or frames to confirm their existence, determining whether the identified characteristics are significant enough to fail inspection. The pass/fail criteria for each part or feature of a part may be defined for that part based on its design, functionality, location/role in a process or system, the application of the part or feature, and use conditions of the part or feature.

At block 274, the inspection results and/or inspection may be stored on the local, cloud, and/or remote server. In some embodiments, the inspection results and/or inspection may be uploaded or otherwise transmitted to another local, cloud, and/or remote server for storage and/or additional processing. For example, in some embodiments, the inspection results and/or inspection may be added to a training data set or otherwise used to train, evaluate, or otherwise improve a machine learning algorithm for processing subsequent inspections. At block 276, the results may be displayed via the web portal or native application. At block 278, results are downloaded to the mobile or edge device. At block 280, the results are displayed on the mobile or edge device.

FIG. 5 is a schematic of an embodiment of the part inspection system 10 in which the inspector performs an inspection from a remote field location 300. The field location 300 may be a well site, a drilling rig, a platform, an assembly/disassembly location, and so forth. As shown, the inspector 12 disposed at field location 300 utilizes the mobile device 16 to capture video and/or images of a part 18. The mobile device 16 may or may not perform partial, lite, or full processing of the inspection. The inspection data (e.g., video/images, metadata, information about the part, inspector notes, lite results, full results, etc.) and/or locally processed inspection results may be uploaded to a cloud/remote server 24 via the internet using networking equipment 22, such as a local gateway device or router, a satellite dish/transmitter 302, and/or a cellular network, including one or more cellular towers 304.

FIG. 6 is a flow chart of an example inspection process 400 from the perspective of a mobile device used to perform inspections. At block 402, an inspection is initiated on the mobile device. Inspection initiation may include, for example, accessing an application, web application, or portal, and starting a new inspection. Alternatively, a new inspection may be started by initiating the camera function on the mobile device. At block 404, a user may provide inspection identification data via the mobile device. This may include, for example, an inspection identification number, a part identification number, information about the inspection, information about the part, a work order number, a part number, a serial number, etc. In some embodiments, inspection identification data may be manually input via a graphical user interface of the mobile device, selected via drop-down menus, or otherwise provided via the graphical user interface of the mobile device. In further embodiments, inspection identification data may be provided by scanning identifying information, such as stamped, etched, stenciled, engraved, and so forth text or code on the part or on an identification/name plate using Optical Character Recognition (OCR), scanning a machine-readable code, such as a barcode, a quick response (QR) code, a radio-frequency identification (RFID) tag, near field communication (NFC), Bluetooth, or some other data transmission technique.

At block 406, a video is captured of the part being inspected. For example, the inspector may initiate video recording and capture a video (e.g., 15 second, 30 seconds, 1minute, etc.) while moving the mobile device around to capture one or more features of the part from a variety of different perspectives. Similar to as described previously with regard to FIG. 4, if results are to be processed on the device, in real time, the process 400 may proceed to a real time processing routine 408, wherein each frame of the video is processed by the machine learning models (block 410) on the device. The video display may be immediately updated to show the predicted results (block 412). In some embodiments, feedback on the video quality is provided to the user with on screen messages. The feedback results may be generated with machine learning models, for example, height of the camera above the part is too large, or the video image is blurry, sensors built in to the device, for example the angle/tilt of the device, or other means. At block 414, the model predictions are written to a real time processed video for uploading to the local/cloud/remote server. At block 416, the inspector may provide feedback on the inspected feature. For example, the inspector may provide notes about the part, identify particular characteristics/features of the part, and so forth to be considered with the captured video. At decision 418, the process 400 determines whether all features of the part that are to be inspected have been inspected. If not, the process 400 returns to block 406 for the remaining features. If all of the features to be inspected have been inspected, the process 400 proceeds to block 420 and reviews raw and real time processed video, real time results, and other data. For example, the process 400 may be evaluating clarity of collected videos, whether inspected features and in the frame and remain in the frame during video capture, whether the inspection identification data and/or inspector feedback matches what is found in the collected video, and so forth.

At block 422, data (e.g., the collected videos, inspection identification data, inspector feedback, added metadata, etc.) is uploaded to the cloud/remote server for processing. At block 424, the process 400 may receive an indication from the cloud/remote server (e.g., via native application, web application, portal, push notification, email, short messaging service (SMS), etc.) that the inspection has been processed. At block 426, in some embodiments, data (e.g., the collected videos, inspection identification data, inspector feedback, added metadata, etc.) may be stored and used for evaluating and/or retraining the machine learning-based inspection model. At block 428, the results of the inspection may be made available via native application, web application, portal, and so forth. In some embodiments, at block 430, inspection results may be pushed or pulled to the mobile device for local storage and review.

FIG. 7 is a schematic illustrating an example inspection processing workflow 500. In the illustrated embodiment, a captured video 502 of one or more surfaces and/or one or more features of an inspected part is input to a skip connection-based encoder-decoder based deep neural network model 504 for analysis and to an image classification model 506. During analysis, each frame of the input video and/or individual images are analyzed. Though a part may have multiple features, each having one or more surfaces, surfaces and/or features may be processed and analyzed separately using other damage identification models.

At block 508, the encoder-decoder based deep neural network model 504 performs Region-Of-Interest (ROI) identification and/or surface detection. Accordingly, for each frame of the video or image, the ROI is identified consisting of the part's surface and critical areas. For example, an ROI model identifies the parts surface and critical areas on the parts surface. A critical area is an area of the part at which damage could lead to inspection failure and/or asset failure during operation. For example, for a gate valve gate, a critical area may be an area at or near a sealing surface, such that damage in the critical area may cause leaks during use of the gate valve. A surface is an area of interest of the part that includes the critical area. At block 510, the encoder-decoder based deep neural network model 504 and the image classification model 506 utilize one or more damage models to identify damage on the identified part's surface. Damage is defined as defects on the surface of the part that could cause failure if located in critical areas. For example, damage may include physical damage such as scratching, pitting and/or indentations, cracks, erosion, galling, pitting corrosion, abrasion, wear, mechanical damage, loss of applied coatings, foreign material on the surface such as machine cuttings/swarf, incomplete de-burring or edges, grease, sand, paint and/or pen markings, and so forth. The ROI model and the damage model are trained using an encode-decoder based pixel level semantic image segmentation technique. The neural network uses skip connections from the output of convolution blocks to the corresponding input of the transposed block at the same level. The skip connections are useful for gradient flow in the network and also provide information about different scales of image size. Smaller image scales may be helpful in segment localization, whereas larger image scales may help the classification be more robust. In some embodiments, the image classification model 506 identifies if the frames of the video contain certain types of damage. In some embodiments, the model will identify if certain types of damage present in the image and where in the image they are located. At block 512, identified surfaces and/or regions of interest and identified damage may or may not be combined with feedback data for active learning 512 of the encoder-decoder based deep neural network model 504. The deep learning-based approach utilized by the present embodiment uses a large amount of data for model training. Accordingly, manual image annotation may be supplemented with computer vision implemented in a data annotation tool to create the data for initial model training. For ongoing active learning of the deep learning models, a web-based collaborative data testing and annotation platform is used that utilizes continuous data testing, data monitoring, prediction corrections and/or model enhancements.

At block 514, identified damaged is categorized into potential failure or pass categories based on the damage's location, area, shape, and so forth based on one or more failure models. In some embodiments, the failure analysis 514 may apply one or more of a group of failure models to perform contour boundary detection to identify boundaries of both critical and damage areas, contour intersection identification, and/or contour tracking from frame to frame. At block 516, results of multiple models may be compared the to determine an inspection result for the part. In one embodiment, if one or more models has identified a failure, the feature or part is considered failed. At block 518, a disposition determination is made. At bock 520, a processed video and/or analysis report may be generated and output indicating whether or not the part passed or failed inspection and why.

In some embodiments, in blocks 516 and/or 518, parts that fail inspection may be assessed for their degree of failure to determine if repair and returning to service is possible and/or practical. Repair may include, for example, polishing, lapping, machining, re-coating, inlay welding, and so forth. Repaired parts may be tested upon repair and reinstallation and/or reassembly. Functional testing may be utilized to determine whether the repaired asset functions to specification (e.g., a piston can travel the length of its housing, a valve can fully open and fully close, etc.). In some embodiments, a pressure test may be performed with fluid (e.g., water) or an inert gas (e.g., Nitrogen). To perform a pressure test, the asset may be filled with the test medium, air purged, and pressure increased up to a set test pressure, which may or may not exceed the maximum working pressure. Testing may also be performed on assets that are in use at regular intervals (e.g., 1, 2 or 5 years). The asset passing a pressure test may demonstrate that all seals, sealing mechanisms, and/or sealing devices have been installed correctly and are capable of maintaining a seal.

As previously described (e.g., with regard to FIG. 4), in some embodiments, video may be captured and analyzed in real time or near real time. Accordingly, FIG. 8 is a schematic illustrating an example inspection processing workflow 550 for processing an inspection in real time or near real time. In such embodiments, each frame of video may be output by a camera (block 552) via a capture session (block 554). The frames (block 556) may be displayed on a display of the device in a real time preview 558 within the capture session, along with processed frames 560. Raw captured frames 556 may be combined into a raw video output 562. Raw captured frames 556 from block 502 may be passed to the encoder-decoder based deep neural network model 504 and the image classification model 506 for processing. For example, as previously described, an encoder model may identify surfaces (block 508) and damage (block 510). In some embodiments, the image classification model 506 may be applied to determine if certain types of damage are present in certain locations on a surface (block 510). Further, the image classification model 506 may assess the quality of the frames/video (block 564) and provide real time or near real time feedback (block 566) on the display of the device. In some embodiments, the models may also be configured to analyze the quality of the video by identifying improper camera height (e.g., too low, too high), blur, glare, insufficient light, etc. In such embodiments, video quality feedback may also be displayed on the display of the mobile or edge device so an operator can make adjustments to improve video quality.

A failure model may be used to perform failure analysis (block 514) to determine if the damage meets the criteria for failure. At block 516, results of multiple models may be compared the to determine an inspection result for the part. In one embodiment, if one or more models has identified a failure, the feature or part is considered failed. At block 518, a disposition determination is made. At block 520, a processed video and/or analysis report may be generated and output indicating whether or not the part passed or failed inspection and why.

In some embodiments, identified surfaces, damage, and failure may be overlaid on video frames and displayed via a display of the mobile/edge device (block 564). The overlaid frames may be saved as process video files. Upon completion of the video being taken, the mobile or edge device may display an indication of whether the part has passed or failed inspection, determine disposition of the part, and output results of the inspection (e.g., a report, data, images/video, etc.).

FIG. 9 is a flow chart of a process 600 for processing an inspection. At block 601, an inspection video for a feature is captured. At block 602, the process 600 examines an image or video frame and identifies an ROI, which may include, for example, a surface of the part and/or one or more critical areas. At block 604, the process 600 identifies any damage on the part surface. At block 606, the process 600 determines whether the identified damage meets a critical criteria. For example, the process may determine whether the identified damage is in or near the critical area, the size, depth, and/or severity of the damage, and so forth. If the damage does not meet the critical criteria, the process 600 proceeds to block 608 and proceeds to the next image or video frame. If the damage does meet the critical criteria, the process 600 proceeds to block 610 and determines if the damage meets a tracking criteria. For example, the process 600 may determine whether the identified damage appears in adjacent and/or nearby frames. If not, the process may determine that the identified damage is not actually damage, but rather a feature of the video/image that merely appears to be damage. If the damage does not meet the tracking criteria, the process 600 proceeds to block 608 and proceeds to the next image or video frame. If the damage does meet the tracking criteria, the process 600 proceeds to block 612 and determines whether the tracking count meets a threshold value. For example, the process may determine whether the damage appears in a threshold number of images or frames. If the tracking count does not meet the threshold value, the process 600 proceeds to block 608 and proceeds to the next image or video frame. If the tracking count does meet the threshold value, the process 600 proceeds to block 614 and flags the damage as possible critical damage. At block 616, the process determines whether the end of the video or collection of images has been reached. If not, the process 600 proceeds to block 608 and proceeds to the next image or video frame.

If the end of the video or collection of images has been reached, the process 600 proceeds to block 618 and determines whether the quantity of critical damage exceeds a threshold value. If not, the process 600 proceeds to block 620 and determines that the part feature has passed inspection. If the quantity of critical damage exceeds the threshold value, the process 600 proceeds to block 622 and determines that the part feature has failed inspection. At block 624, the process 600 predicts remedial action to address the damage. In some embodiments, the process 600 may also evaluate the likelihood of success of one or more candidate remedial actions.

FIG. 10 is a flow chart of an embodiment of a process 650 for performing inspections of parts. As previously described, inspections may be performed in real time as inspection video or photos of features are captured (block 651), or after the fact upon submission (e.g., upload) of captured video or photos. At block 652, the process 650 applies a damage detection model to determine if certain damage types are present in a video frame or image and/or whether certain damage types are present in one or more specific locations within the video frame or image. If real time processing is being used, the process 650 proceeds to real-time processing subroutine 654 and, at decision 656 determines whether a video parameter has been exceeded. If so, the process 650 proceeds to block 658 and displays feedback on the display of the device. For example, the process 650 may consider camera height/distance from part, blur, light etc. In some embodiments, consideration of video quality may be limited to real-time inspections.

At decision 660, the process 650 determines whether damage has been detected. If no damage has been detected, the process proceeds to block 662 and moves to the next frame of the video. If, at decision 660, damage has been detected, the process 664 proceeds to decision 664 and determines if the end of the video has been reached. If not, the process proceeds to block 662 and moves to the next frame of the video. If so, the process 650 proceeds to block 666 and quantifies the damage present. At decision 668, the process 650 determines whether a number of continuous frames showing damage exceeds a threshold number. If yes, the inspection result for the feature is fail (block 670), and if so, the inspection result for the feature is pass (block 672). If the inspection result for the feature is fail, the process 650 may proceed to block 671 and predict remedial actions to address the inspection failure.

FIG. 11 is a flow chart of an embodiment of a process 674 for performing inspections of parts. As previously described, inspections may be performed in real time, or after the fact upon submission of captured video. At block 676, a part is provided for inspection. At block 678, an inspection of a feature of the part is initiated by capturing inspection video of the feature. At block 680, the process 674 may process the video using an encoder-based deep learning model, resulting in failure analysis results (block 682). In parallel, at block 684, the process 674 may process the video with an image classification model, resulting in image classification results (block 686). Logic, criteria, and/or rules specific to the particular part, feature, and/or application of the part (block 688) may be applied to determine whether or not the feature passes or fails inspection (block 690). For example, if a feature fails the deep learning model, the feature fails the inspection, or if a feature fails the classification model, the feature ails the inspection.

At decision 692, the process 674 determines whether all of the features of the part have been inspected. If not, the process 674 returns to block 678 and performs inspection of the next feature. If all of the features have been inspected, the process 674 proceeds to decision 694 and determines whether the number of failed features of the part meets or exceeds a threshold value. If not, the process 674 proceeds to block 696 and determines that the part has passed inspection. If so, the process 674 proceeds to block 698 and determines that the part has failed inspection.

In one example, each gate valve gate includes two features: a front face and a back face. In such an embodiment, the failure model assesses if there are continuous damage or damage clusters of a sufficient area across a critical area which may lead to a leak. A side of the gate valve gate is considered failed when there are a one or more areas of critical damage. The whole part (e.g., gate valve gate) fails inspection if a single side fails inspection. If the gate valve gate fails, the predicted remedial action may be, for example, to polish, lap, recoat, or scrap the gate valve gate, dependent upon the quantities of critical damage.

FIG. 12 is a schematic illustrating specifics of the failure analysis block 512 in the inspection processing workflow 500 of FIG. 7. As shown, the critical surface predictions identified during surface detection 506 and the damage predictions generated during damage identification 508 act as inputs to the failure analysis 512. During the failure analysis 512, a failure model uses damage boundary identification 700 and critical surface boundary identification 702 to assesses if any identified damage is likely to lead to failure. To identify critical damage, contour identification and image dilation-based, fault detection techniques are used. Specifically, the failure model assesses if damage occurs in the critical area, and if the damage is of sufficient size to lead to failure of the part. In this context, damage may be a single occurrence of damage or combined cluster of damage located close to one another. An ellipse-based damage projection 704 is used to identify critical damage by making a projection of the damage area and/or cluster of damage areas using contour ellipse fitting. Determination of intersection, if any, of the critical surface boundary 702 and projected ellipse 704 occurs at step 706. Parameters such as the acceptable size and shape of the projected ellipse and the number of critical area boundary intercepts may be defined per part type or per part feature being inspected. A failure score may be calculated 708 based on the damage, the critical surface, and the intersection between the damage and the critical surface. To make the categorization more robust, damage contour tracking 710 is used to track damage and damage clusters across frames in the video. Once the damage conforming to the defined criteria is tracked across multiple frames, the damage may be flagged as critical. The failure model predicts whether the feature passes or fails inspection based upon whether the quantity (surface area, projected area, volume, pixels, etc.) of critical damage exceeds the defined threshold for the specific feature. If the quantity of critical damage exceeds the threshold, the feature fails. If the quantity of critical damage does not exceed the threshold, the feature passes. In some embodiments, a comprehensive analysis report may be generated that includes a novel failure score and a damage score. In some embodiments, when a feature fails, a prediction may be made identifying one or more remedial actions to address the critical damage. In some embodiments, predictions as to the success of the remedial actions may also be generated. After individual features of the part have been analyzed separately, a combined assessment of the part is made. If the number of failed features exceeds the defined limit for the part, or particular features of interest fail, the part fails inspection.

FIG. 13 is a schematic illustrating a process 800 for training deep learning models used to process inspections. In one embodiment, data may be generated via initial data generation (IDG) 802 (no existing model) and continuous data generation (CDG) 804 (existing model). Initial raw images 806 are provided to the IDG phase 802. In one embodiment, Subject Matter Experts (SMEs) may manually annotate raw images (block 808). In another embodiment, initial identification of features may be done utilizing using a naïve computer-vision based technique with convolution filter-based predictions 810.

A naïve computer-vision based technique is used to automatically annotate the image using a combination of Gaussian, Sobel and Gabor filters for preliminary damage and region of interest prediction. In some embodiments, the computer-vision based damage detection technique may be integrated into the annotation tool. The SMEs may then use the tool to correct the prediction to generate second SME updates 812.

The SME annotations 808 or updates 812 may be used to generate an initial training data set 814, which may be used for initial model training 816 to generate an initial model 818. CDG 804 may utilize the trained model 818 (e.g., once the trained model 818 has surpassed a baseline accuracy for prediction). As new raw images are received (block 820), the trained model 818 may be used to generate predictions (block 822). The SMEs can correct the model predictions 822 to generate SME updates (block 824) to generate a new training data set (block 826) to be used for continuous model training (block 816). In some embodiments, various image augmentations such as image zoom, horizontal/vertical flips, Zero Components Analysis (ZCA) whitening and image rotation may be applied to increase the initial training and test data set. Hyper parameter tuning may also be incorporated to boost the accuracies of the models on the initial dataset.

FIG. 14 is a flow chart of a process 830 for initial training and retraining of image classification models used for inspections. Initial raw images 806 are provided to the IDG phase 802. An SME performs manual classification and/or tagging of the images (block 832) to produce an initial training data set (block 834). The training data set may also include data from one or more previous inspections. At block 836 the initial training of the model is performed using the training data set, resulting in a trained model (block 838). As new raw images are received (block 840), the trained model 838 may be used to generate predictions (block 842). The SMEs can correct the model predictions 842 to generate SME updates (block 844) to generate a new training data set (block 846) to be used for continuous model training (block 836).

The process 830 may then proceed back to processing new images (block 840) from inspections and repeat the cycle of blocks 842, 844, and 846 until the image classification model is determined to be sufficiently trained or until the image classification model is retired.

FIG. 15 is a schematic of a web-based, or native application-based, end to end video testing and data generation platform 850 used for processing part inspections. An inspection video 502 is provided via a web portal or application 100. The application and/or web portal may communicate with a virtual machine (e.g., running on a backend server 852) via one or more APIs 854. Data and inspection results (e.g., raw and processed images, etc.) may be stored in a database 856. A video prediction pipeline 858 (e.g., running on a virtual machine) separates the video into images (e.g., frames) 860 and predictions are run on these images using earlier versions of developed models 504, 506, and failure analysis (block 514) performed, resulting in an inspection result 880, a video with prediction results 878, and randomly selected image overlaid with damage predictions 862. The random images and their predictions (block 862) can be reviewed and corrected by the SME via an annotation tool 864, resulting in manual corrections 866. Corrected image annotations (block 868) may then be added to the training and testing dataset for further model training (block 870), testing (block 872), validation (874), and generation of an evolved model 876. As the model evolves, the accuracy of auto-generated predictions increase, resulting in fewer corrections and less work for the SME performing data tagging. As the cycle of testing, annotation, and training loop continues, the models continuously improve and the time the SME spends correcting predictions decreases. Upon completion of inspection processing, an inspection result video (block 878) and inspection results (block 880) may be available for review.

FIG. 16 illustrates an example graphical user interface of the predicted model results, screenshot 900. As shown, it includes a video window 902, a video details window 904, and a video images window 906. The video window 902 is configured to display the original inspection video 908 and the predicted results video 910 side-by-side. The video window 902 includes a progress bar 912 disposed below the original inspection video 908 and the predicted results video 910. Accordingly, the video window 902 displays synchronized versions of the original inspection video 908 and the predicted results video 910 such that the video window 902 displays frames from the original inspection video 908 and the predicted results video 910 at the same moment in the video, and displays the time (e.g., graphically, numerically, etc.) via the progress bar 912.

The video details window 904 includes details about the video, the inspection, and/or the part being inspected. For example, as shown in FIG. 16, the video details window 904 may include information for notes from the inspector, damage score, part number, work order number, location, serial number, inspection status, version model, etc.

The video images window 906 includes individual frames or images from the inspection video. In one embodiment, the images are chosen randomly from the video to prevent bias when training the models. When an image is selected from the video images window 906, the image annotation tool shifts to an image annotation mode.

FIG. 17 illustrates a screenshot 1000 of an example graphical user interface of the image annotation tool used by SMEs to annotate images to train the model. Training and test images may be prepared by tagging images with a part's surface, critical areas, and damage regions of interest. When an initial training dataset is not available, a data annotation tool may utilize using continuous mouse click tracking, mask overlaying, and overlaid mask editing. Specifically, the image annotation tool (e.g., run via the web or a local installation) may be used by an SME to identify the parts surface, critical areas, and damage on raw images of the part. In some embodiments, the tool may include capabilities for increasing or decreasing the size of the marker, visualizing only the mask, visualizing only the image, visualizing mask-overlaid on image, moving to next/previous images, and so forth. In some embodiments, areas of interest on images or video frames may be colored or otherwise marked by an SME. For example, an SME may utilize three layers or colors corresponding to part surfaces, critical areas, and damage, which may be annotated independently. In some embodiments, the tool may include features for increasing a size of the marker, changing an opacity of a prediction mask, collaborative data tagging, pushing the corrected image to cloud storage, and so forth.

As shown, the selected image is displayed in an image annotation window 1002. The SME may select a drawing operation from a drawing operation window 1004 and then use a mouse, touchscreen, stylus, etc. to annotate the image by drawing certain features. As shown, the drawing operation window 1004 may include options for brush size, opacity, etc. The image selection window 1006 may allow a user to select what is being communicated with the annotations. For example, the user may select critical areas, damage, part surfaces, and so forth. In some embodiments, the user may be able to provide additional information, such as labeling surfaces, providing information about certain types of surfaces/areas, identifying particular types of damage (e.g., scratching, pitting and/or indentations, cracks, erosion, galling, pitting corrosion, abrasion, wear, mechanical damage, loss of applied coatings, foreign material on the surface such as machine cuttings/swarf, incomplete de-burring or edges, grease, sand, paint and/or pen markings, and so forth). In some embodiments, the image saving status window 1008 may also include selectable options for identifying what has been annotated. The image action window 1010 allows the SME to close the annotation mode and return the image annotation tool to video mode. This may include, for example, determining whether to save or discard the annotated image.

Images annotated by SMEs may be incorporated into training data set and subsequently used to train models used for inspection processing. Accordingly, a video received from an inspector may be processed using the trained models to determine whether the inspected part passes or fails inspection. Because the inspection tool is used across the enterprise, inspection results are consistent across the enterprise and not subject to human error.

FIG. 18 illustrates a block diagram of example components of a computing device 1100 that could be used as the imaging device, mobile device, computing device, workstation, terminal, local server, remote server, cloud server, network equipment, edge devices, gateway devices, etc. As used herein, a computing device 1100 may be implemented as one or more computing systems including laptop, notebook, desktop, tablet, or workstation computers, as well as server type devices or portable, communication type devices, such as cellular telephones and/or other suitable computing devices.

As illustrated, the computing device 1100 may include various hardware components, such as one or more processors 1102, one or more busses 1104, memory 1106, input structures 1108, a power source 1110, a network interface 1112, a user interface 1114, a camera 1116, and/or other computer components useful in performing the functions described herein.

The one or more processors 1102 may include, in certain implementations, microprocessors configured to execute instructions stored in the memory 1106 or other accessible locations. Alternatively, the one or more processors 1102 may be implemented as application-specific integrated circuits (ASICs), field-programmable gate arrays (FPGAs), and/or other devices designed to perform functions discussed herein in a dedicated manner. As will be appreciated, multiple processors 1102 or processing components may be used to perform functions discussed herein in a distributed or parallel manner.

The memory 1106 may encompass any tangible, non-transitory medium for storing data or executable routines. Although shown for convenience as a single block in FIG. 18, the memory 1106 may encompass various discrete media in the same or different physical locations. The one or more processors 1102 may access data in the memory 1106 via one or more busses 1104.

The input structures 1108 may allow a user to input data and/or commands to the device 1100 and may include mice, touchpads, touchscreens, keyboards, controllers, and so forth. The power source 1110 can be any suitable source for providing power to the various components of the computing device 1100, including line and battery power. In the depicted example, the device 1100 includes a network interface 1112. Such a network interface 1112 may allow communication with other devices on a network using one or more communication protocols. In the depicted example, the device 1100 includes a user interface 1114, such as a display that may display images or data provided by the one or more processors 1102. The user interface 1114 may include, for example, a monitor, a display, and so forth. The camera 1116 may include a camera for capturing video or still images. In other embodiments, the camera 1116 may include other imaging sensors, such as infrared sensors, radar, x-ray, gamma ray, magnetic resonance imaging (MRI) sensors, or other types of sensors that may generate still or moving images, even of those images may not be photographs or video. As will be appreciated, in a real-world context a processor-based system, such as the computing device 1100 of FIG. 18, may be employed to implement some or all of the present approach, such as capturing inspection videos/images, transmitting inspection data, processing inspection data, receiving feedback/annotations, training a machine learning model, implementing a machine learning, model, and so forth. Accordingly, the computing device 1100 may include other built-in or external sensors such as accelerometers, gyroscopes, or other sensors that may be used to give feedback to the user on video quality or other characteristics of an inspection.

The disclosed techniques are directed to a machine-learning based part inspection system that provides more uniform part inspection results across an enterprise, regardless of who performs the inspection. Specifically, a user uses a mobile device to capture a video inspection of a part. The video may then be processed using one or more machine learning models. Processing may be done locally on the mobile or edge device, on a local server, on a remote server, on a cloud-based server, or some combination thereof. The analysis may include processing the video frame-by-frame. For each frame, processing may include identifying a region of interest, identifying instances of damage, identifying the type of damage, identifying the location of the damage, determining if there is intersection between the region of interest and the instances of damage, and then determining if the number of instances of damage that intersect the regions of interest exceed a threshold value. If so, the feature fails inspection. If not, the feature passes inspection.

The machine learning models may include, for example, an encoder-decoder-based deep neural network and image classification models. The machine learning models may be trained by receiving annotated or classified images received from subject matter experts (SMEs). The annotated images include annotations identifying particular features in images, such as surfaces, regions of interest, damage, and so forth. Classified images may include the type of damage, the location of the damage, and, in some cases, other features. Once trained, the machine learning models may be used to process inspections received from inspectors throughout the enterprise. Periodically, the machine learning models may be further trained based on feedback from inspectors and/or SMEs.

Technical effects of implementing the disclosed techniques include faster, more accurate, and more consistent equipment inspections across an enterprise regardless of inspector experience, bias, location, or other factors. Further, more accurate and more consistent inspections may result in few resources utilized replacing parts that do not need to be replaced, less down time and/or time off line, and also fewer resources maintaining large inventories of replacement parts.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112 (f). However, for any claims containing elements designated in any other manner, it is intended that such elements are not to be interpreted under 35 U.S.C. 112(f).

1. A system, comprising:
a processor; and
a memory, accessible by the processor, the memory storing instructions that, when executed by the processor, cause the processor to perform operations comprising:
receiving a plurality of images of a surface of a part;
for each image of the plurality of images, applying one or more machine learning models to:
identify one or more regions of interest on the surface of the part;
identify one or more instances of damage on the surface of the part; and
determine that the one or more instances of damage intersect with the one or more regions of interest;
determine whether the one or more instances of damage that intersect with the one or more regions of interest from the plurality of images exceeds a threshold value;
in response to the one or more instances of damage that intersect with the one or more regions of interest from the plurality of images exceeding the threshold value, generating an indication that the surface of the part has failed inspection; and
in response to the one or more instances of damage that intersect with the one or more regions of interest from the plurality of images not exceeding the threshold value, generating an indication that the surface of the part has passed inspection.

2. The system of claim 1, wherein the one or more machine learning models comprise an encoder-decoder-based deep neural network, an image classification model, or both.

3. The system of claim 1, wherein:
identifying the one or more regions of interest on the surface of the part comprises identifying a first boundary of the one or more regions of interest; and
identifying the one or more instances of damage on the surface of the part comprises identifying one or more second respective boundaries of the one or more instances of damage.

4. The system of claim 3, wherein determining that the one or more instances of damage intersect with the one or more region of interests comprises generating projections of respective ellipses of the one or more second respective boundaries of the one or more instances of damage onto the first boundary of the one or more regions of interest via contour ellipse fitting.

5. The system of claim 1, wherein the operations comprise:
determining whether the one or more instances of damage on the surface of the part are of a particular type of damage, and
identifying a location of the one or more instances of damage of the particular type of damage within the image.

6. The system of claim 1, wherein the operations comprise tracking the one or more instances of damage on the surface of the part through the plurality of images.

7. The system of claim 6, wherein tracking the one or more instances of damage on the surface of the part through the plurality of images comprises:
identifying a particular instance of damage of the one or more instances of damage in a first image of the plurality of images; and
identifying the particular instance of damage of the one or more instances of damage in a second image of the plurality of images, wherein the first image precedes the second image in the plurality of images.

8. The system of claim 1, wherein the operations comprise:
receiving one or more annotated or classified images, wherein the one or more annotated images comprise annotations identifying an additional region of interest on an additional surface of the part, one or more additional instances of damage on the additional region of interest on the additional surface of the part, or both, and wherein the one or more classified images comprise identification of one or more particular types of damage, identification of one or more features, a location of the one or more particular types of damage, a location of the one or more features in the image, or any combination thereof; and
training the one or more machine learning models based on the one or more annotated images or classified images.

9. A method, comprising:
receiving a plurality of annotated images or classified images, wherein the each of the plurality of annotated images comprises annotations identifying a surface of interest of a part, one or more instances of damage on the part, or both, and wherein the one or more classified images comprise identification of one or more particular types of damage, identification of one or more features, a location of the one or more particular types of damage, a location of the one or more features in the image, or any combination thereof; and
training one or more machine learning models based on the plurality of annotated images or classified images to analyze an additional plurality of images of an additional surface of an additional part to:
identify an additional region of interest on the additional surface of the additional part;
identify one or more additional instances of damage on the additional surface of the additional part; and
determine that the one or more additional instances of damage intersect with the additional region of interest.

10. The method of claim 9, wherein the one or more machine learning models comprise an encoder-decoder-based deep neural network, an image classification model, or both.

11. The method of claim 9, wherein identifying the additional region of interest on the additional surface of the additional part comprises identifying a first boundary of the additional region of interest.

12. The method of claim 11, wherein identifying the one or more additional instances of damage on the additional surface of the additional part comprises identifying one or more second respective boundaries of the one or more instances of damage.

13. The method of claim 12, comprising:
determining whether the one or more instances of damage on the surface of the part are of a particular type of damage, and
identifying a location of the one or more instances of damage of the particular type of damage within the image.

14. The method of claim 12, wherein determining that the one or more additional instances of damage intersect with the additional region of interest comprises generating projections of respective ellipses of the one or more second respective boundaries of the one or more additional instances of damage onto the first boundary of the additional region of interest via contour ellipse fitting.

15. The method of claim 9, comprising:
receiving the additional plurality of images of the additional surface of the additional part:
for each image of the additional plurality of images, applying the one or more machine learning models to:
identify the additional region of interest on the additional surface of the part:
identify the one or more additional instances of damage on the additional surface of the additional part; and
determine that the one or more additional instances of damage intersect with the additional region of interest;
determine whether the one or more additional instances of damage that intersect with the additional region of interest from the plurality of frames exceeds a threshold value;
in response to the one or more additional instances of damage that intersect with the additional region of interest from the plurality of frames exceeding the threshold value, generating an indication that the additional surface of the additional part has failed inspection; and
in response to the one or more additional instances of damage that intersect with the additional region of interest from the plurality of frames not exceeding the threshold value, generating an indication that the surface of the part has passed inspection.

16. A non-transitory computer readable medium storing instructions that, when executed by a processor, cause the processor to perform operations comprising:
receiving, via a user interface of a mobile device, instructions to begin an inspection of a surface of a part;
capturing, via a camera of the mobile device, a video of the surface of the part as the mobile device is moved about the part;
receiving, via the user interface of the mobile device, information associated with the part, the inspection, or both;
generating, via the processor of the mobile device, an inspection data set comprising the video and the information; and
displaying, via the user interface of the mobile device, an indication of whether the surface of the part passed the inspection or failed the inspection based on a machine learning-based analysis of the inspection data set.

17. The non-transitory computer readable medium of claim 16, wherein the operations comprise:
separating the video into a plurality of frames;
for each frame of the plurality of frames, applying one or more machine learning models to:
identify a region of interest on the surface of the part;
identify one or more instances of damage on the surface of the part; and
determine that the one or more instances of damage intersect with the region of interest;
determine whether the one or more instances of damage that intersect with the region of interest from the plurality of frames exceeds a threshold value;
in response to the one or more instances of damage that intersect with the region of interest from the plurality of frames exceeding the threshold value, displaying, via the user interface of the mobile device, an indication that the surface of the part has failed inspection; and
in response to the one or more instances of damage that intersect with the region of interest from the plurality of frames not exceeding the threshold value, displaying, via the user interface of the mobile device, an indication that the surface of the part has passed inspection.

18. The non-transitory computer readable medium of claim 16, wherein the operations comprise:
transmitting the inspection data set to a local server, a remote server, a cloud-based server, or a combination thereof for the machine learning-based analysis of the inspection data set; and
receiving from the remote server, the cloud-based server, or the combination thereof, results of the machine learning-based analysis of the inspection data set.

19. The non-transitory computer readable medium of claim 18, wherein the operations comprise performing, prior to transmitting the inspection data set to the local server, the remote server, the cloud-based server, or the combination thereof, one or more processing or pre-processing operations on the inspection data set.

20. The non-transitory computer readable medium of claim 16, wherein the operations comprise recognizing identifying information on the surface of the part.
